(19) United States
(12) Patent Application Publication
(10) Pub. No.: US 2022/0188545 A1
(43) Pub. Date: Jun. 16, 2022

(54) AUGMENTED REALITY ENHANCED SITUATIONAL AWARENESS

(71) Applicant: International Business Machines Corporation, Armonk, NY (US)

(72) Inventors: Raghuveer Prasad Nagar, Kota (IN); Sarbajit K. Rakshit, Kolkata (IN); Manjit Singh Sodhi, Bangalore (IN); Rahul Jain, Kolkata (IN)

(21) Appl. No.: 17/117,637

(22) Filed: Dec. 10, 2020

(51) Int. Cl. G06K 9/00; G06T 19/00

(52) U.S. Cl. CPC G06K 9/00671; G06T 19/006

(57) ABSTRACT

A method for enhancing the situational awareness of a user to a problem within an area. The method includes one or more computer receiving visual information corresponding to an area from a device associated with a user. The method further includes receiving data from a group of one or more sensors within the area, where the area includes a plurality of physical elements. The method further includes determining that a first problem is present within the area and a first physical element in the area that corresponds to the first problem, based on analyzing the data received from the group of sensors. The method further includes generating augmented reality (AR) content related to the first problem present within the area. The method further includes displaying, via the device associated with the user, the generated AR content related to the problem within the visual information corresponding to the area.

### BACKGROUND OF THE INVENTION

The present invention relates generally to the field of augmented reality (AR), and more particularly to generating AR content based on information obtained from Internet-of-Things sensors.

Internet of Things (IoT) is defined as the ability of various physical devices and every-day objects to be connected to each other through the Internet. Embedded with electronics, Internet connectivity, and other forms of hardware (such as sensors), IoT devices can communicate and interact with others over the Internet, wireless network, and other inter-device communication methods such that the IoT devices can provide information and be remotely monitored/controlled. IoT devices can include human-to-device communication. For example, a user utilizes an application on a mobile device to contact IoT devices to identify a service and/or navigate within a building or venue. In addition, some IoT devices (e.g., edge devices) in one area can obtain data from sensors and perform edge computing analyses and interface with other IoT devices in an area.

Augmented reality (AR) is a view of a physical, real-world environment with elements augmented (overlaid) by computer-generated sensory input, such as graphical information, haptic events, auditory and/or other sensory effects. Generally, augmentation occurs in near real-time and in semantic context with various environmental elements. AR overlays can integrate virtual information (e.g., shapes, colors, text, links to information, computer generated graphics, etc.) within and/or associated to the images or a video stream associated with features within the physical world. Various electronic (e.g., computing) devices can include AR capabilities and/or receive AR content information, such as smartphones, smart glasses, a head-up display, a tablet computer, etc.

### SUMMARY

According to an aspect of the present invention, there is a method, computer program product, and/or system for enhancing the situational awareness of a user to a problem within an area. The method includes at least one computer processor receiving visual information corresponding to an area from a device associated with a user. The method further includes at least one computer processor receiving data from a group of one or more sensors within the area, wherein the area includes a plurality of physical elements. The method further includes at least one computer processor receiving data from a group of one or more sensors within the area where the area further includes a plurality of physical elements. The method at least one computer processor determining that a first problem is present within the area and a first physical element in the area that corresponds to the first problem, based on analyzing the data received from the group of sensors. The method at least one computer processor generating augmented reality (AR) content related to the first problem present within the area. The method at least one computer processor displaying via the device of the user, the generated AR content related to the problem within the visual information corresponding to the area.

### BRIEF DESCRIPTION OF THE DRAWINGS

FIG. 1 illustrates a networked site environment, in accordance with an embodiment of the present invention.

FIG. 2 depicts a flowchart of steps of a situational awareness program, in accordance with an embodiment of the present invention.

FIG. 3 depicts a flowchart of steps of a temporal visualization program, in accordance with an embodiment of the present invention.

FIG. 4 is a block diagram of components of a computer, in accordance with an embodiment of the present invention.

### DETAILED DESCRIPTION

Embodiments of the present invention recognize that various problems present (i.e., occurring) within an area can begin as minor issues and individuals may often ignore or delay addressing a problem. Embodiments of the present invention recognize that an ignored or unresolved problem may gradually worsen and generate other events and/or hazards, which can ultimately create a catastrophic situation or event if not rectified. Similarly, embodiments of the present invention recognize if one individual only applies a temporary fix to a problem within an area, a different individual that enters the area at a later occasion may be unaware the problem is not fully rectified and unknowingly expose themselves to a hazard associated with the problem or perform actions that can exacerbate the problem.

Embodiments of the present invention recognize that in some cases, a problem within an area is self-evident because the problem generates one or more sensory components (e.g., visual, vibrational, olfactory, and/or audible elements). In other cases, an individual that enters an area is unaware of a problem because the problem cannot detect via various sensory components because the problem is hidden within an object, enclosure, or piece of equipment. Embodiments of the present invention recognize that it is easier to identify a problem utilizing automatically sensor data obtained and providing the sensor data or analyses of the sensor data to the individual rather than utilizing the observational skills and abilities of the individual.

Embodiments of the present invention improve the probability that a user (e.g., an individual) notices a problem, informs the user of potential hazards associated with the problem; logs how the problem is rectified; or determines that the problem was patched or ignored. Embodiments of the present invention automatically detect and identify a problem within an area utilizing data obtained from sensors within the area and/or included within various elements or equipment within the area. Embodiments of the present invention utilize the analyses and contextual information obtained from various sensors and/or IoT-enabled devices within elements of an area and/or associated with the area to whether a problem is present and/or predict that a problem may occur at some point in the future due to a condition within an area. Conditions may include environmental factors that increase wear, corrosion, stress equipment; construction in progress; increased traffic, such as people, vehicles, and/or materials; etc.

One aspect of the present invention utilizes augmented reality (AR) capabilities of a device of a user, such as an AR headset, smart-glasses, a mobile phone, etc.; to attract the attention or focus of the user (i.e., an individual) to a particular location within the area where a problem is present, a hazard is present, or a problem is predicted to occur in the future. Embodiments of the present invention determine the type of problem and subsequently determine imagery representing a problem and/or a hazard related to the problem. Embodiments of the present invention utilize AR and computer-generated graphics to enhance and/or magnify the imagery associated with the problem and embed the enhanced imagery within the field of view of the user. The imagery associated with the problem moves within the field of view of the device of the user until the user/device faces the location of the problem. If an embodiment of the present invention detects that the attention of the user is not directed towards the location of the problem, then embodiments of the present invention further modify the AR content to make the problem and the location of the problem more evident and/or initiate other actions via the device of the user.

Another aspect of the present invention utilizes temporal information input by a user, information related to the problem, and actions the user performs or elects to implement to mitigate or temporarily rectify the problem as factors utilized by a suite of analytic programs. Embodiments of the present invention use the outputs and predictions of the analytics suite to instruct an automated computer graphics program to generate images, virtual reality (VR) renderings, and/or amination sequences related to forecasts and/or time-lapse sequences of projected events depicting a future state of the problem and/or area where the problem is located.

The descriptions of the various scenarios, instances, and examples related to the present invention have been presented for purposes of illustration but are not intended to be exhaustive or limited to the embodiments disclosed.

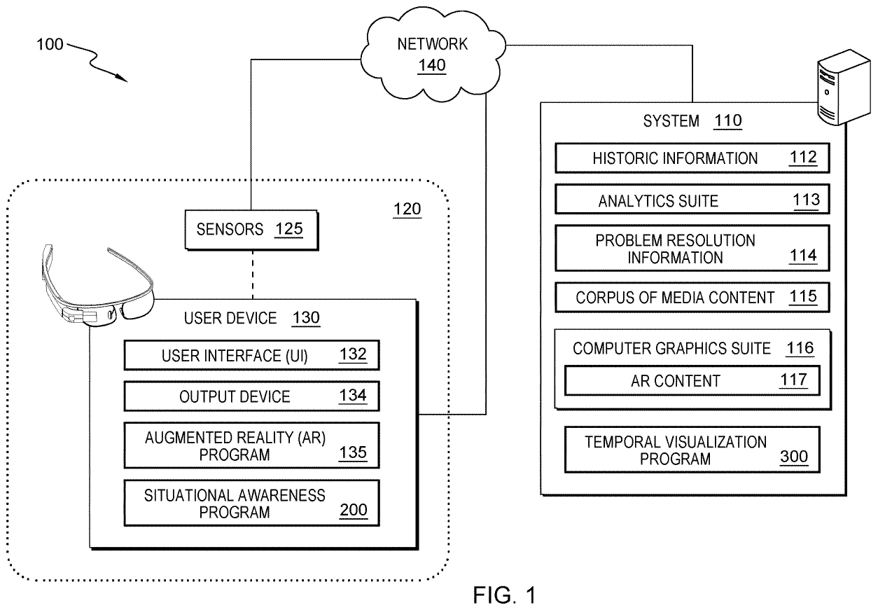

The present invention will now be described in detail with reference to the Figures. FIG. 1 is a functional block diagram illustrating environment 100, in accordance with embodiments of the present invention. In one embodiment, environment 100 includes system 110, sensors 125, and user device 130 all interconnected over network 140. In an embodiment, environment 100 includes one or more instances of area 120 monitored by respective instances of sensors 125.

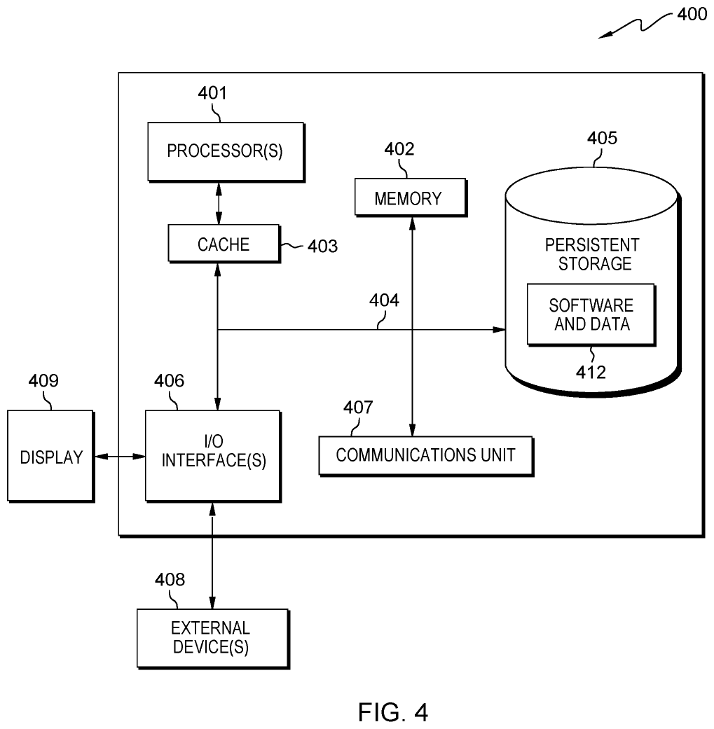

System 110 and user device 130 may be laptop computers, tablet computers, personal computers, desktop computers, or any programmable computer systems known in the art. In certain embodiments, system 110 and user device 130 represents a computer system utilizing clustered computers and components (e.g., database server computers, application server computers, etc.) that act as a single pool of seamless resources when accessed through network 140, as is common in data centers and with cloud-computing applications. In some embodiments, user device 130 can be a personal digital assistant (PDA), a smart phone, a wearable device (e.g., smart glasses, a smart watch, e-textiles, an AR headset, etc.). In general, system 110 and user device 130 are representative of any programmable electronic device or combination of programmable electronic devices capable of executing machine readable program instructions and communicating via network 140 with sensors 125. System 110 and user device 130 may include components, as depicted and described in further detail with respect to FIG. 4, in accordance with embodiments of the present invention.

System 110 includes historic information 112, analytics suite 113, problem resolution information 114, corpus of media content 115, computer graphics suite 116, temporal visualization program 300, and a plurality of other programs and data (not shown). Examples of other programs and data included in system 110 may include one or more databases, an web browser; cognitive programs, such as a natural language processing (NLP) program, an image recognition program, a semantic query program, a video analysis program, an audio recognition program, etc.; a location mapping/geo-fencing program; proximity thresholds; a haptic event generation program; maps of instances of area 120; lists of repair supplies and tools; functions and/or operation performed within an instance of area 120; etc.

Historic information 112 includes a plurality of information respectively associated with instances of area 120, such as a log of sensor data and analyses related to elements within area 120, a status log of problems (e.g., resolved, unresolved, delays, patched or partially fixed, etc.) associated with area 120, a severity description and/or rating related to previous problems, hazards associated with problems, warning messages, etc. In one embodiment, historic information 112 also includes a list of equipment and equipment locations, facility schematics (e.g., electrical, plumbing, ventilation, etc.), sensor locations, etc., respectively associated with an instance of area 120. In some embodiments, historic information 112 also include operational values and/or settings associated with elements of area 120, such as amperage, temperature, and a noise level associated with various operating conditions. In other embodiments, historic information 112 can also include reference information related to a plurality of other problems, events, and respective hazards obtained from other network-accessible resources, such as a corporate maintenance and safety database or a regulatory agency.

Analytics suite 113 includes a plurality of analysis programs that utilize data from sensors 125, historic information 112, and/or problem resolution information 114. In some scenarios, analytics suite 113 determines that one or more problems are present within area 120 and whether a related hazard may be present. In other scenarios, analytics suite 113 determines a future state associated with a problem within area 120 based on various factors. For example, a future state associated with a problem may include one or more hazards generated or released by the problem, triggering another problem to occur, elements of area 120 that will be affected by the problem, a change of size of an area within area 120 affected by the problem or a hazard, a cost to rectify the problem, skills and/or personal protective equipment (PPE) required to rectify the problem, a schedule of adjustments dictated to compensate for a problem, etc. Various factors may include a time-frame, one or more actions of a user, a lack of action by a user, whether problems are concurrently present within area 120, whether one problem associated with area 120 affects (e.g., interacts, exacerbates) another problem that is present within area 120.

In some embodiments, analytics suite 113 also estimates a severity rating of a current problem and can extrapolate a change to the severity rating of a problem based on time and/or one or more actions of a user. In addition, analytics suite 113 can determine changes related to hazards and/or hazard interactions associated with problems within area 120 based on time and/or one or more actions of the user. In various embodiments, analytics suite 113 also utilizes information obtained from other programs included within system 110 and/or user device 130, such as an image recognition program, an audio analysis program, etc. In some embodiments, analytics suite 113 can utilize data within historic information 112 and data from sensors 125 to predict the probability of a future occurrence of a problem within area 120.

Problem resolution information 114 includes information related to rectifying a problem or potential problem identified within an instance of area 120. Problem resolution information 114 may include decisions trees; softcopy manuals; historic problems and corresponding skills, actions, supplies, PPE, and/or equipment utilized to rectify a previous instance of the problem; acceptable problem resolution delay values; etc. In various embodiments, problem resolution information 114 includes root-cause information and corresponding corrective actions utilized to rectify, resolve, or repair a problem. In some embodiments, problem resolution information 114 can also represent resources related to a plurality of problems, events and respective corrective actions, hazard interactions, and/or outcomes obtained from other resources accessible via network 140, such as corporate health and safety databases, a virtual engineer, links to softcopy manuals, safety and hazard information available from a regulatory agency associated with health and safety, etc.

Corpus of media content 115 is representative of a library, database, and/or a collection of media files (e.g., content) related to problems and/or hazards, such as graphical representations, images, videos, animated images, etc. Corpus of media content 115 can also include audio files of various problems or hazards, such as metal scraping, fire crackling, arcing electricity, water flowing, structural material failing, etc. In some embodiments, corpus of media content 115 can also represent of media files identified for public use or licensed by aspects of the present invention and obtained from other sources accessible via network 140, such as the Internet. In other embodiments, Corpus of media content 115 includes content produced by computer graphics suite 116, such as generated animation sequences or extracted content.

Computer graphics suite 116 represents a suite of automated programs that edit, extract and/or generate visual and/or audio from elements within corpus of media content 115 and/or other network-accessible sources to generate and/or modify AR and/or VR content. AR and/or VR content can be stored for future use within AR content 117. In an embodiment, computer graphics suite 116 generates AR content based on information obtained from at least situational awareness program 200. In some embodiments, computer graphics suite 116 modifies AR and/or VR content based on instructions from situational awareness program 200.

In other embodiments, computer graphics suite 116 utilizes temporal information input by a user, information generated by analytics suite 113, and information and/or instructions from temporal visualization program 300 to create time-based images, amination sequences, and/or audio events related to a progression of a problem as a function of time, or depicting a potential future state of a problem.

In one embodiment, AR content 117 is library of media files obtained from corpus of media content 115 and situational awareness program 200 that are associated with one or more problems within area 120. In another embodiment, AR content 117 also includes media files obtained from corpus of media content 115 by temporal visualization program 300 that are associated with one or more problems within area 120. In a further embodiment, AR content 117 further includes AR and/or VR content modified and/or generated by computer graphics suite 116 in response to instructions from temporal visualization program 300.

Temporal visualization program 300 is a program that generates AR and/or VR content (e.g., media files) related to one or more future states of a problem and/or area 120 based on information related to the problem, information associated with actions or lack of actions by a user to rectify a problem, and one or more temporal dictates input by a user. In one example, temporal visualization program 300 enables a user to obtain a visual forecast (i.e., prediction) of a state of a problem at a fixed point in the future or viewing the changing states of the problem as a function of time (e.g., fast-forward, temporal increments, etc.), such as food spoiling in response to a refrigeration unit failing. In another example, temporal visualization program 300 can interface with computer graphics suite 116 to generate AR and/or VR content associated with future state of the problem related to an identified problem if the user elects to perform an incomplete fix, such as a partial or temporary repair, modifies parameters and/or settings, etc.

In various embodiments, temporal visualization program 300 utilizes information obtained from analytics suite 113 and inputs from a user to instruct computer graphics suite 116 to generate temporally manipulated AR and/or VR content for display to the user. In a further embodiment, temporal visualization program 300 can determine interactions and generate AR/VR content in response to identifying that two or more problems are present concurrently (e.g., during the same time interval) within the area 120. For example, if one problem is not at least partially fixed, then temporal visualization program 300 determines additional problems and/or hazards that arise from an interaction between problems, such as trying to repair a live electrical problem when standing water is present nearby; thereby, increasing the risk and/or severity (e.g., exacerbating) of an electrical shock hazard.

Area 120 may represent a physically bounded area, such as a room; a geo-fenced area within a larger area, such as a room of a venue or an isle of a warehouse; and/or a dynamically-defined area in proximity to (e.g., around) the user with respect to the location of user device 130. Area 120 can include a plurality of elements (e.g., physical features) (not shown), such as equipment; process tools; computers; utility infrastructures, such as heating, cooling, and ventilation systems, a plumbing system, electrical distribution system, and communication networks; one or more safety systems; physical infrastructure, such as drip pans and sumps, transport mechanisms, etc. Some elements of area 120 include IoT-enabled devices (not shown). In some embodiments, area 120 also includes in-transit elements, such a perishable goods, or items being fabricated. In some cases, one or more problems (not shown) are present within area 120 while a user is within area 120. A problem may refer to operating at out-of-specification conditions; effects and/or deficiencies associated with one or more elements of area 120, such as damage, wear, structural fatigue, corrosion, embrittlement, deformation of a structure, biological decomposition, a leak, electrical arcing, etc. A problem may also generate hazards, such as electrical shock or a slippery surface.

Sensors 125 are representative of a plurality of sensors and/or sensors operatively coupled to Internet-of-Things (IoT) enabled devices that determine information related to area 120 and/or included within various elements (previously discussed above) associated with area 120. Sensors 125 may include thermal sensors, noise sensors, chemical sensors, an artificial nose, various electrical sensors (e.g., a voltage sensor, a current sensor, a thermistor, a harmonic distortion sensor, etc.), a moisture sensor, environmental sensors (e.g., temperature, humidity, air-flow, etc.), etc. In some embodiments, one or more sensors of sensors 125 can also transmit information different from sensor measurements, such as operating parameters; a beacon signal; identification information; contextual information associated with the element of area 120 that includes the sensor, such as an equipment ID or sub-assembly ID; etc. In various embodiments, one or more sensors of sensors 125 may include components, as depicted and described in further detail with respect to FIG. 4, in accordance with embodiments of the present invention.

In an embodiment, some sensors of sensors 125 associated with area 120 utilize network 140 to communicate with system 110 and user device 130. In other embodiments, one or more sensors of sensors 125 can analyze and selectively transmit data based on determining anomalous or out-of-specification conditions. In another embodiment, a one or more other sensors of sensors 125 associated with area 120 and include within an IoT-enabled device (not shown) can wirelessly communicate with user device 130 without utilizing network 140. In some scenarios, user device 130 can communicate raw and/or analyzed data from one or more sensors of sensors 125 to system 110 via network 140.

In addition, a user (e.g., an owner, administrator, etc.) that controls and/or is responsible for an instance of area 120 has opted-in and authorizes that sensors 125 associated with the instance area 120 can collect data associated with the instance of area 120. Further, the user (e.g., an owner, administrator, etc.) that controls and/or is responsible for an instance of area 120 has opted-in for situational awareness program 200 and/or temporal visualization program 300 to process data received from sensors 125 and store the received data within historic data 112 and/or other locations, in accordance with various embodiments of the present invention.

In an embodiment, user device 130 includes user interface (UI) 132, output device 134, augmented reality (AR) program 135, situational awareness program 200, and a plurality of programs and data (not shown). Examples of other programs and data may include a global positioning system (GPS) software, a web browser, a camera/video application, audio analysis program, image recognition software, cognitive apps, maps of one or more instances of area 120, a local copy of at least a portion of historic information 112, data obtained from sensors 125, etc. In a further embodiment, user device 130 represents a remote monitoring system included within area 120 or a robotic monitoring system that can traverse area 120 as opposed to a user entering an instance of area 120, such as responsive to detecting a hazard that can affect the user.

In various embodiments, user device 130 also includes and/or is operatively coupled to a plurality of other hardware features (not shown) that are utilized in association with AR program 135 and/or situational awareness program 200, such as one or more cameras; a speaker; headphones; a haptic actuator; wireless communication technologies and protocols to interface with one or more sensors of sensors 125, such as LTE-M, narrowband IoT (NB-IoT), near field communication (NFC), etc.; a compass and/or an inertial monitoring system to sense a position, orientation and/or one or more physical actions of a user; and/or a different instance of output device 134, such as a AR headset; a pair of smart glasses; a head-up display.

Various embodiments of the present invention can utilize various accessible data sources, such as historic data 112, problem resolution information 114, which may include storage devices and content associated with the user. In example embodiments, instances of situational awareness program 200 and/or temporal visualization program 300 allow the user to opt-in or opt-out of exposing types and categories of information. Instances of situational awareness program 200 and/or temporal visualization program 300 enable the authorized and secure handling of user information, such as location information, as well as types and categories of information that may have been obtained, is maintained, and/or is accessible. In another example, a user opts-in to allow situational awareness program 200 to log decision or status information but to anonymize the ID of the user that logged a decision, updated a status, or performed one or more actions. The user can be provided with notice of the collection of types and categories of information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

In one embodiment, UI 132 may be a graphical user interface (GUI) or a web user interface (WUI). UI 132 can display text, documents, forms, web browser windows, user options, application interfaces, and instructions for operation, and include the information, such as graphic, text, and sound that a program presents to a user. In various embodiments, UI 132 displays one or more icons representing applications that a user can execute in association with user device 130. In one example, UI 132 represents of the application interface of situational awareness program 200 and/or temporal visualization program 300. In addition, UI 132 can control sequences of actions that the user utilizes to respond and/or confirm actions associated with situational awareness program 200 and/or temporal visualization program 300.

In some embodiments, a user of user device 130 can interact with UI 132 via a singular device, such as a touch screen (e.g., display) that performs both input to a GUI/WUI, and as an output device (e.g., a display) presenting a plurality of icons associated with apps and/or images depicting one or more executing software applications. In various embodiments, UI 132 accepts input from a plurality of input/output (I/O) devices (not shown) including, but not limited to, a keyboard, a tactile sensor interface (e.g., a touch screen, a touchpad), a virtual interface device, and/or a natural user interface (e.g., voice control unit, motion capture device, eye tracking, cyberglove, head-up display, etc.). In addition to the audio and visual interactions, UI 132 may receive input in response to a user of device 130 utilizing natural language, such as written words or spoken words, that device 130 identifies as information and/or commands.

In one embodiment, output device 134 is included within user device 130 and displays AR/VR content and images/video obtained from camera (not shown) of user device 130. In another embodiment, output device 134 is representative of a display technology operative coupled to user device 130, such as a head-up display, smart glasses, virtual retinal display, etc. In various embodiments, output device 134 is a touch screen device that can operate as both a display and an input device. In some embodiments, output device 134 also displays UI 132 and GUI elements related to other programs that execute on user device 130. In various embodiments, differing instances of output device 134 present different information and/or graphical elements to a user. In a further embodiment, output device 134 represents a one or more displays outside of area 120 and associated with a remote or robotic monitoring system.

AR program 135 is an augmented reality program that embeds AR elements and/or AR content overlays within a captured picture (i.e., a still image) or a video feed obtained by a camera associated with user device 130. In one embodiment, AR program 135 embeds and/or moves AR content and/or AR content overlays as instructed and/or generated by situational awareness program 200 and/or temporal visualization program 300. In another embodiment, AR program 135 displays VR content generated by computer graphics suite 116. In some embodiments, AR program 135 can add and/or modify AR and/or VR content received from system 110 based on instructions from situational awareness program 200, such as increasing a size of an AR content element, adding visual effects, lengthening the duration of a sensor event, etc. In other embodiments, AR program 135 display multiple instance of a field-of-field of view.

Situational awareness program 200 is a program that utilizes data from among sensors 125 associated with area 120 to determine whether a problem and/or hazard is present; or has the potential to occur within area 120. In an embodiment, responsive to determining that problem(s) and/or one or more hazards are present or may potentially occur within area 120, situational awareness program 200 utilizes AR program 135 to embed AR content related to the problem, situation, and/or hazard within an image or video feed corresponding to a portion of area 120. In various embodiments, situational awareness program 200 utilizes network 140 to access the plurality of resources, files, and programs of system 110.

In some embodiments, if situational awareness program 200 determines that the attention of the user is not attracted to the identified location associated the occurring problem, then situational awareness program 200 further modifies (e.g., augments, amplifies, etc.) AR content and/or the presentation of AR content to attract the attention of the user. In various embodiments, situational awareness program 200 can respond to a determination that two or more problems are present within area 120 and generate differing AR/VR content based on user inputs. In a further embodiment, situational awareness program 200 interfaces with temporal visualization program 300 and obtains other AR content and/or VR content related to the occurring problem based on various user input related to an incomplete fix of the, such as a partial or temporary repair, modifying/adjusting operating setting, etc.; and/or determining a future state of the problem within area 120 based on temporal information input by the user.

Network 140 can be, for example, a local area network (LAN), a telecommunications network (e.g., a portion of a cellular network), a wireless local area network (WLAN), such as an intranet, a wide area network (WAN), such as the Internet, or any combination of the previous and can include wired, wireless, or fiber optic connections. In general, network 140 can be any combination of connections and protocols that will support communications between system 110, sensors 125, user device 130, and/or the Internet, in accordance with embodiments of the present invention. In various embodiments, network 140 operates locally via wired, wireless, or optical connections and can be any combination of connections and protocols (e.g., personal area network (PAN), Bluetooth®, near field communication (NFC), laser, infrared, ultrasonic, etc.).

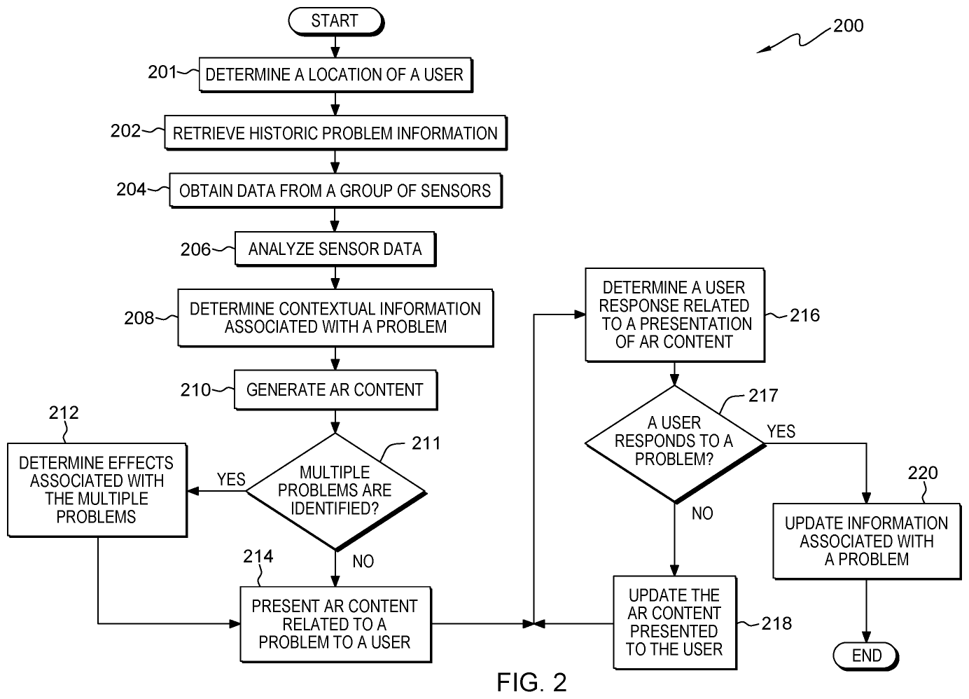

FIG. 2 is a flowchart depicting operational steps for situational awareness program 200, a program for analyzing information received from one or more sensors associated with an area to identify a problem and subsequently modifying AR content related to the problem to attract the attention or focus of a user to the identified problem, in accordance with embodiments of the present invention. In various embodiments, situational awareness program 200 interfaces with temporal visualization program 300 to generate AR/VR content based on one or more choices of a user in response to a problem, and/or modifying AR/VR content to depict potential changes to a problem as a function of one or more temporal dictates. In an embodiment, a user can dynamically modify the generation of AR and/or VR content by temporal visualization program 300 while situational awareness program 200 presents the AR/VR content to the user.

In step 201, situational awareness program 200 determines a location of a user. Situational awareness program 200 can utilize user device 130 to continuously monitor the location and movements of a user within area 120. Situational awareness program 200 utilizes user device 130 to determine that a user approaches area 120, determines the location of the user within area 120, or that the user exits area 120. In some embodiments, situational awareness program 200 utilizes of user device 130 to also determine an orientation of the user. In various embodiments, situational awareness program 200 dictates that a user opt-in for one or more types of data, such an ID of a user, an ID associated with user device 130, tracking data, etc. For example, a user may opt-in for situational awareness program 200 to track user device 130 but opt-out of identifying user device 130 or the user associated with user device 130.

In step 202, situational awareness program 200 retrieves historic problem information. In one embodiment, responsive to determining that a user enters area 120 or approaches within a proximity threshold of area 120, situational awareness program 200 retrieves information from historic information 112 to determine whether a known problem is active (e.g., ongoing) or is incompletely fully rectified. Situational awareness program 200 may also retrieve information from historic information 112 related to prior instances of rectified problems associate with area 120. In various embodiments, situational awareness program 200 retrieves further information associated with an instance of area 120 from various sources, such as a list of equipment and respective values associated with operations, utility diagrams, layouts, sensor locations, etc.

In step 204, situational awareness program 200 obtains data from a group of sensors. Situational awareness program 200 may receive data from among sensors of sensors 125 via network 140 and/or directly to user device 130 via a wireless communication technology. In some scenarios, situational awareness program 200 polls sensors 125 to obtain data related to elements of area 120. In other scenarios, situational awareness program 200 automatically obtains receives data from among the sensors of sensors 125 based on the location of user device 130, such as upon entering area 120.

In another embodiment, situational awareness program 200 obtains data related to a group of sensors of sensors 125 within area 120 associated with a previously identified problem from historic information 112. In a further embodiment, situational awareness program 200 determines other data associated with area 120 based on one or more features and/or programs of user device 130.

In step 206, situational awareness program 200 analyzes sensor data. Situational awareness program 200 analyzes sensor data to determine whether one or more problems are present within area 120 or may occur in future within area 120. If the analyses indicates that a problem is not present within area 120, then situational awareness program 200 terminates. In an embodiment, situational awareness program 200 compares the data obtained from sensors 125 with sensor data and/or equipment operating specifications included within historic information 112 to determine whether the comparison indicates that a problem is present within area 120. Situational awareness program 200 may also include data obtained from one or more features of data user device 130 within various analyses. In addition, situational awareness program 200 can identify the one or more elements within area 120 that are associated with a problem.

In another embodiment, situational awareness program 200 receives results that indicate whether or not a problem is present within are 120 from one or more IoT-enabled devices (not shown) that include of sensors and can perform in-situ analyses. In some embodiments, situational awareness program 200 utilizes analytics suite 113 and/or a cognitive program to execute more complex analyses, such as determining a severity rating related to the problem, determining future impacts or events a problem can produce, etc.

In step 208, situational awareness program 200 determines contextual information associated with the problem. Situational awareness program 200 determines contextual information based on information included within one or more resources, such as historic information 112 or other information stored within system 110, such as operations performed within a portion of area 120. Contextual information associated with a problem may include one or more hazards that the problem releases or generates, such as fumes, sparks, water; a location within area 120 where the problem is occurring; a description of the problem, such as “within a power distribution panel” or “embedded within sub-assembly 325 of equipment ID X2B”; etc. In a further embodiment, situational awareness program 200 also determines contextual information associated with area 120 based a features and/or program of user device 130, such as identifying a sound and determining a direction of the sound.

In some embodiments, responsive to determining that a problem releases or generates a hazard, situational awareness program 200 utilizes network 140 to access other resources (not shown) to determine whether the hazard is a threat to the user and/or other elements of area 120. In another embodiment, situational awareness program 200 also accesses problem resolution information 114 to identify one or more actions to rectify or temporarily fix a problem.

In step 210, situational awareness program 200 generates AR content. In an embodiment, situational awareness program 200 utilizes information associated with a problem and/or a hazard related to the problem to select at least one media file from among corpus of media content 115 or AR content 117 that represents the problem and/or a hazard related to the problem. In one example, AR content related to a slow leak can be represented by a pipe with a short line and two drops of liquid, whereas a more severe leak can be represented by a pipe with a large crack and a stream of liquid. In another example, AR content related to an electrical problem may be depicted as a pair of lightning bolts. If arcing is also present, then situational awareness program 200 may download audio content from corpus of media content 115 or utilize computer graphics suite 116 to apply a strobe effect to the lightning bolts within the media file.

In various embodiments, situational awareness program 200 instructs AR program 135 to modify AR content based on information related to the problem. In one example, situational awareness program 200 instructs AR program 135 to apply differing visual effects around the AR content based on whether the problem is exposed or enclose; another visual effect if the problem is behind another element of the displayed portion of area 120; add a directional indication, such as an arrow if the location of the problem is outside of the portion of area 120 displayed within output device 134. In another example, situational awareness program 200 instructs AR program 135 to change the brightness of the AR content or modify a visual effect, such as a color around the AR content based on a severity rating of the problem. In a further embodiment, if situational awareness program 200 cannot identify AR content applicable to the problem within corpus of media content 115 or other network-accessible resources, then situational awareness program 200 utilizes a cognitive program and computer graphics suite 116 to extract and generate AR content from imagery related to one or more aspects of the problem.

Still referring to step 210, in some embodiments situational awareness program 200 also generates AR content overlays that include contextual information associated with the problem, a hazard related to the problem, and/or other relevant information. For example, situational awareness program 200 generates an AR content overlay that is a hover-over element that includes an equipment ID, a severity rating of the problem, a warning message, status information, etc. In a further embodiment, if situational awareness program 200 cannot identify a representation of the problem or a related hazard, then situational awareness program 200 interfaces with computer graphics suite 116 to create one or more media files (e.g., AR content) that respectively represent the problem and/or a related hazard utilizing other stored media files within corpus of medic content 115 or other network-accessible media files.

In decision step 211, situational awareness program 200 determines whether multiple problems are identified. In one embodiment, situational awareness program 200 determines that multiple problems are identified based on analyses performed in step 206. In another embodiment, situational awareness program 200 determines that multiple problems are identified on analyses performed in step 206 and a status log of problems within historic information 112.

Responsive to determining that multiple problems are identified (Yes branch, decision step 211), situational awareness program 200 determines effects associated with the multiple problems (step 212).

In step 212, situational awareness program 200 determines effects associated with the multiple problems. Situational awareness program 200 may utilize one or more cognitive program (not shown) to search and analyze information included within various information sources to determine effects and/or hazards respectively associated with a problem. In an embodiment, situational awareness program 200 determines effects (e.g., impacts) and/or hazards associated with the multiple problems based on information included within historic information 112, an analysis of sensor data, problem resolution information 114, and/or other internal information sources. For example, identifying a stuck value within one portion of area 120 causes overheating problems within equipment in a different portion of area 120.

In another embodiment, situational awareness program 200 also utilizes analytics suite 113 to determine a priority for addressing (e.g., fixing) multiple problems within area 120. In some embodiments, situational awareness program 200 searches network-accessible resources, such as safety and hazard information available from one or more regulatory agencies to determine whether the effects and/or hazards of two or more problems interact and increase the severity of a problem and/or increase a risk to the user within area 120. For example, a reduced ventilation problem at the same time as a problem that generates a fume hazard may contaminate area 120 or risk the user breathing an unsafe level of the fume. Subsequently, situational awareness program 200 presents AR content related to a problem to a user in step 214.

Referring to decision step 211, responsive to determining that multiple problems are not identified (No branch, decision step 211), situational awareness program 200 presents AR content related to a problem to a user (step 214).

In step 214, situational awareness program 200 presents AR content related to a problem to a user. Situational awareness program 200 utilizes AR program 135 to display AR and/or VR content via output device 134. In one embodiment, situational awareness program 200 selects the AR content to present based on determining that the location of the problem within area 120 and/or other factors (previously discussed with respect to step 210). In some embodiments, responsive to determining that multiple problems are present within area 120, situational awareness program 200 presents AR content related to each problem. In addition, situational awareness program 200 may also present additional AR content associated with an interaction among multiple problems and/or hazards related to the interaction among multiple problems, such as a facemask icon, electrically insulating boots and gloves, etc. The additional AR content may also include content overlays that include contextual and/or descriptive information associated with the interaction among multiple problems. Further, situational awareness program 200 can instruct AR program 135 to adjust the presentation of respective AR content based on severity rating respectively associated with a problem.

In one scenario, if situational awareness program 200 determines the problem is located within the portion of area 120 that is displayed within output device 134, then situational awareness program 200 applies the AR content related to the problem in proximity to the visual location of the problem displayed within output device 134. In another scenario, if situational awareness program 200 determines the problem is unseen (e.g., enclosed, behind other elements of area 120, etc.), then situational awareness program 200 presents modified AR content related to a problem at an approximate visual location of the problem display within output device 134. In other scenarios, if situational awareness program 200 determines the location of the problem is not within the displayed portion of area 120, then situational awareness program 200 instructs AR program 135 to further include a directional indication related to the location of the problem and respectively associated with the AR content related to a problem.

In step 216, situational awareness program 200 determines a user response related to a presentation of AR content. In one embodiment, situational awareness program 200 determines that the user responds to a presentation of AR content based on user device moving towards the location of a problem. In various embodiments, situational awareness program 200 determines that a user response based on the user activating UI 132 to review information related to actions to perform to rectify a problem or identify a temporary fix to a problem determined in step 208.

In another embodiment, situational awareness program 200 determines that that a user does not respond to a presentation of AR content based on determining that user device 130 moves and/or orients in a direction away from the location of a problem. In some embodiments, situational awareness program 200 determines that the user only acknowledges the problem associated with the presented AR based on information input to UI 132. In other embodiments, situational awareness program 200 determines that the user acknowledges the problem associated with the presented AR content based the user executing temporal visualization program 300 to determine one or more future states of a problem.

In decision step 217, situational awareness program 200 determines whether a user responds to a problem. In one embodiment, situational awareness program 200 determines that the user responds to the problem by determining that the user accesses at least problem resolution information 114 and that a subsequent analysis of data received from sensors indicates a lack of a problem (e.g., the problem is rectified or temporarily fixed). In some embodiments, situational awareness program 200 determines that a user responds by acknowledging the presence of a problem via US 132 but elects not rectify the problem. In another embodiment, situational awareness program 200 determines that a user does not responds to a problem based on the movement and/or orientation of user device 130 in a direction different from the location of the problem. In other embodiments, situational awareness program 200 determines that the user does not respond to a problem based the user executing temporal visualization program 300 to determine one or more future states of a problem based on various inputs and/or selections.

Responsive to determining that a user does not respond to a problem (No branch, decision step 217), situational awareness program 200 updates the AR content presented to the user (step 218).

In step 218, situational awareness program 200 updates the AR content presented to the user. In one embodiment, responsive to determining that the user does not respond to a problem based moving away from the location of the problem, situational awareness program 200 updates and/or adds AR content to attract the attention of the user and/or prompt a user response to the problem. In one example, situational awareness program 200 may instruct AR program 135 to modify one or more aspects of the AR content related to the problem, such as increasing a size of the AR content or modifying a direction indication associated with the AR content. Situational awareness program 200 may continue to instruct AR program 135 to modify AR content based subsequent responses or lack of responses of the user to a problem. In another example, situational awareness program 200 also instructs AR program 135 to move modified AR content to stay in the field of view of output device 134 as a user moves. Responsive to presenting updated AR and/or VR content to a user, situational awareness program 200 loops to step 216 to determine a user response related to another presentation of AR and/or VR content.

In other embodiments, situational awareness program 200 presents updated AR and/or VR content received from temporal visualization program 300 that depicts one or more future states of a problem as opposed to AR content related to the problem, is associated with determining that a user delays responding to a problem to determine one or more future states of a problem, and/or content associated with an unrectified problem. In some embodiments, responsive to receiving multiple items of AR and/or VR content from temporal visualization program 300, situational awareness program 200 utilizes UI 132 to inform a user about the available content and allow the user to select the content that is presented

Still referring to step 218, in a further embodiment situational awareness program 200 instructs AR program 135 to present multiple instances of the same portion of area 120 that including differing AR/VR content based on dictates of the user, such as different temporal snapshots of one problem, or viewing forecasts of different problems.

Referring to decision step 217, responsive to determining that a user responds to a problem (Yes branch, decision step 217), situational awareness program 200 updates information associated with a problem (step 220).

In step 220, situational awareness program 200 updates information associated with a problem. Situational awareness program 200 updates historic information 112 and/or problem resolution information 114 based on information input by the user and/or subsequent data from among sensors 125. Information input by a user may include information indicating the actions, tools, and/or supplies utilizes to rectify the problem; documenting the problem (e.g., writing notes, taking pictures, updating status information, etc.), hazards found in proximity to the problem, and/or impacts of the problem affecting one or more elements of area 120. In an embodiment, if situational awareness program 200 determines that the user acknowledges the problem but does not rectify the problem, then situational awareness program 200 prompts the user via UI 132 to document the reasons that the problem was not addressed (e.g., fixed) and logs the problem and/or hazards within historic information 112.

In one embodiment, situational awareness program 200 actives another aspect of UI 132 to receive user inputs associated with the user rectifying a problem within area 120. In another embodiment, situational awareness program 200 actives another aspect of UI 132 to receive user inputs associated with the user performing an incomplete fix to the problem, such as applying a temporary repair, modifying parameters/settings, implementing a “work around,” etc. In some embodiments, situational awareness program 200 also stores user information within inputs to temporal visualization program 300; outputs generated by temporal visualization program 300; and/or analytics suite 113, such as VR media files, a description of the progression of a problem, changes related to future states of the problem at dictated points of time, etc.

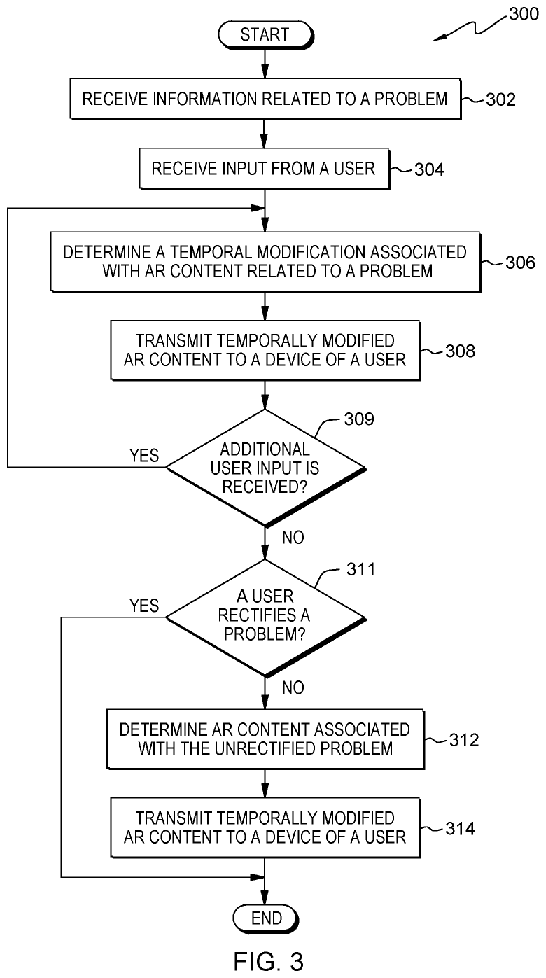

FIG. 3 is a flowchart depicting operational steps for temporal visualization program 300, a program for generate and/or modify AR and/or VR content based on one or more choices of a user in response to a determining that a problem present within an area within area as a function of time, in accordance with embodiments of the present invention. In various embodiments, temporal visualization program 300 executes in response to one or more user actions initiated while situational awareness program 200 executes.

In step 302, temporal visualization program 300 receives information related to a problem. In various embodiments, temporal visualization program 300 receives information related to a problem within area 120 that is determined by situational awareness program 200, such as sensor data, results of one or more analyses, contextual information associated with the problem and/or one or more related hazards, interactions among two or more problems, etc. In some embodiments, temporal visualization program 300 obtains additional information related to a problem from historic problem information 112. In an embodiment, temporal visualization program 300 accesses network-accessible resources to obtain further information related to similar instance of a problem that occurred within an area different from area 120, such as a surveillance video, or a safety lab recording a problem progression under controlled conditions.

In step 304, temporal visualization program 300 receives input from a user. In one embodiment, temporal visualization program 300 receives temporal dictates and factors from a user input via UI 132, such as one or more future periods of time for determining states of a problem, a severity rating threshold, performing or not performing actions to rectify, mitigate, or temporarily fix a problem, an order in which multiple problems are addressed, etc. In some embodiments, temporal visualization program 300 also receives input from a user that dictates how AR and/or VR content is presented to the user, such as at two hour increments, a 10:1 time compression, or at intervals when a severity rating change or hazard is predicted to occur.

In step 306, temporal visualization program 300 determines a temporal modification associated with AR content related to a problem. In various embodiments, temporal visualization program 300 identifies and selects AR and/or VR content from among the plurality of media files included within corpus of media content 115 based on the information obtained in step 302. In one embodiment, temporal visualization program 300 determines one or more temporal modifications associated with the selected AR and/or VR content related to a problem based on the original temporal dictates and factors receives at step 304. In another embodiment, temporal visualization program 300 determines one or more temporal modifications associated with AR and/or VR content related to a problem based on user input received in response to a user viewing temporal modifications of AR and/or VR content (in situational awareness program 200, step 218). In other embodiments, temporal visualization program 300 can further modify AR and/or VR content based on a determination that two or more problems interact and exacerbate one or more aspects and/or hazards of a problem. Temporal visualization program 300 may store modified and/or generated AR and VR content within AR content 117.

In some embodiments, temporal visualization program 300 utilizes computer graphics suite 116 to temporally modify the selected AR and/or VR content based on inputs received from the user. In a further embodiment, if temporal visualization program 300 cannot identify AR and/or VR content related to the problem to temporally modify within corpus of media content 115 or other network-accessible resources, then temporal visualization program 300 utilizes a cognitive program and computer graphics suite 116 extract and generate AR and/or VR content from accessible content that includes at least imagery related to aspects of the problem.

In step 308, temporal visualization program 300 transmits temporally modified AR content to a device of a user. In an embodiment, temporal visualization program 300 transmits temporally modified AR, such as a snapshot of a future state of a problem to user device 130 for presentation by AR program 135 or via situational awareness program 200 in step 218. In another embodiment, temporal visualization program 300 transmits VR content to user device 120, such as an animation sequence associated with a forecast or a progression of states of the problem based on temporal information and factors input by a user.

In decision step 309, temporal visualization program 300 determines whether additional user input is received. In an embodiment, temporal visualization program 300 determines that additional user input is received from user device 130 via UI 132. In one example, temporal visualization program 300 receives information that the user elects to view a VR progression of a different problem associated with area 120. In another example, temporal visualization program 300 receives information that the user elects to implement a temporary fix to a problem and requests to view a VR sequence, in 1-hour snapshots, forecasting the effects to area 120 during the next ten days.

Responsive to receiving additional user input (Yes branch, decision step 309), temporal visualization program 300 loops to step 306 to determine another temporal modification associated with AR and/or VR content related to a problem based on the additional input from the user. Referring to decision step 309, responsive to determining that addition user input is not received (No branch, decision step 311), temporal visualization program 300 determines whether a user rectifies a problem.

In decision step 311, temporal visualization program 300 determines whether a user rectifies a problem. In one embodiment, temporal visualization program 300 determines that a user does not rectifies a problem based on information determined by situational awareness program 200 in step 216 and/or decision step 217, such as the movement of the user relative to a location of a problem; a lack of change to historic information 112; or identifying a log status indicating unresolved, delayed etc., related to the problem. In another embodiment, if multiple problems are present within area 120, then temporal visualization program 300 can respond to another problem that the user does not rectify. In one example, temporal visualization program 300 responds to a user rectifying a low severity rating problem but indicates to delay fixing a problem with a higher severity rating. In another example, temporal visualization program 300 determines that the user rectifies a high severity rating problem and another problem has an acceptable resolution delay duration. In some embodiments, temporal visualization program 300 determines that a user rectifies a problem based on updates to at least historic information 112.

Responsive to determining that a user does not rectify a problem (No branch, decision step 311), temporal visualization program 300 determines AR content associated with the unrectified problem (step 312).

In step 312, temporal visualization program 300 determines AR content associated with the unrectified problem. In an embodiment, temporal visualization program 300 selects AR and/or VR content from among the plurality of media files includes within corpus of media content 115 and AR content 117, and modifies the content based on the information obtained in step 302 and step 304. In another embodiment, temporal visualization program 300 determines one or more temporal modifications associated with AR and/or VR content related to the unrectified problem based on user input received in response to a user viewing temporal modifications of AR and/or VR content (in situational awareness program 200, step 218). In some embodiments, temporal visualization program 300 can further modify AR and/or VR content related to an unrectified problem based on determining that one or more aspects and/or hazards of one unrectified problem are exacerbated by another unrectified problem.

In other embodiments, temporal visualization program 300 utilizes computer graphics suite 116 to apply temporal modifications to the selected AR or VR content based on inputs received from the user. In a further embodiment, if temporal visualization program 300 cannot identify AR and/or VR content related to the unrectified problem to modify within corpus of media content 115 or other network-accessible resources, then temporal visualization program 300 utilizes a cognitive program and computer graphics suite 116 extract and generate AR and/or VR content from accessible content source that includes at least imagery related to aspects of the problem.

In step 314, temporal visualization program 300 transmits temporally modified AR content to a device of a user. In an embodiment, temporal visualization program 300 transmits temporally modified AR and/or VR content to user device 130 for presentation to a user via AR program 135 of user device 130. In some embodiments, temporal visualization program 300 transmits temporally modified AR and/or VR content to user device 130 and interfaces with various aspects of situational awareness program 200 such as the loop associated with step 218, 216, and decision step 217.

Referring to decision step 311, responsive to determining that a user rectifies a problem (Yes, branch, decision step 311), temporal visualization program 300 terminates.

FIG. 4 depicts computer system 400, which is representative system 110 and client device 130. Computer system 400 is also representative of one or more instances of sensors 125. Computer system 400 is an example of a system that includes software and data 412. Computer system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random-access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 412 are stored in persistent storage 405 for access and/or execution by one or more of the respective processor(s) 401 via cache 403 and one or more memories of memory 402. With respect to system 110, software and data 412 historic information 112, analytics suite 113, problem resolution information 114, corpus of media content 115, computer graphics suite 116, AR content 117, temporal visualization program 300, and other programs and data (not shown). With respect to client device 130, software and data 412 includes AR program 135, situational awareness program 200, and other data and programs (not shown). With respect to instances of sensors 125, software and data 412 includes firmware, other data, and programs (not shown).

Communications unit 407, in these examples, provides for communications with other data processing systems or devices, including resources system 110, sensors 125, and client device 130. In these examples, communications unit 407 includes one or more network interface cards and/or wireless communication adapters. Communications unit 407 may provide communications, through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor. Display 409 can also function as a touch screen, such as the display of a tablet computer or a smartphone. Alternatively, display 409 displays information to a user based on a projection technology, such as virtual retinal display, a virtual display, or image projector.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
monitoring a location of a user according to a device worn by the user;
responsive to the location of the user being within a physically bounded area, receiving visual information from the device, the visual information corresponding to the physically bounded area, the visual information including a plurality of physical elements within the physically bounded area;
responsive to receiving the visual information, collecting sensor data from a group of sensors within the physically bounded area and historical problem data for the plurality of physical elements;
identifying a problem that exists with the plurality of physical elements in the physically bounded area in which the user is located by analyzing the sensor data and historical problem data;
responsive to identifying the problem, determining a set of contextual information associated with the problem including a location of a first element of the plurality of physical elements;
generating augmented reality (AR) content from graphical elements related to the problem and the first element;
modifying the AR content by increasing a size of the graphical element related to the first element; and
displaying via the device associated with the user, the modified AR content within the visual information corresponding to the area.

2. The method of claim 1, further comprising:
determining a location and an orientation corresponding the user within the physically bounded area based on the device;
determining a field of view associated with a portion of the area based on the location and the orientation corresponding the user; and
positioning the generated AR content within the determined field of view associated the area based on a location corresponding to the problem.

3-4. (canceled)

5. The method of claim 1, wherein displaying the generated AR content related to the problem further comprises:
determining, by one or more computer processors, a rating respectively associated with the problem; and
adjusting, by one or more computer processors, one or more aspects of the generated AR content based on the determined severity rating respectively associated with the problem.

6. The method of claim 1, wherein the problem includes one or more items selected from the group consisting of an out-of-specification operating condition, a deficiency within an infrastructure of the area, a deficiency within an infrastructure of the area, a deficiency associated with the physical element, and a hazard generated by the physical element.

7. The method of claim 2, further comprising:
determining that the user exits the physically bounded area; and
responsive to determining that the user exits the physically bounded area, modifying one or more aspects of the generated AR related to the problem displayed to the user.

8. A computer program product comprising:
one or more computer readable storage media and program instructions stored on the one or more computer readable storage media, the program instructions readable/executable by one or more computer processors:
program instructions to monitor a location of a user according to a device worn by the user;
program instructions to, responsive to the location of the user being within a physically bounded area, receive visual information from the device, the visual information corresponding to the physically bounded area, the visual information including a plurality of physical elements within the physically bounded area;
program instructions to, responsive to receiving the visual information, collect sensor data from a group of sensors within the physically bounded area and historical problem data for the plurality of physical elements;
program instructions to identify a problem that exists with the plurality of physical elements in the physically bounded area in which the user is located by analyzing the sensor data and historical problem data;
program instructions to, responsive to identifying the problem, determine a set of contextual information associated with the problem including a location of a first element of the plurality of physical elements;
program instructions to generate augmented reality (AR) content from graphical elements related to the problem and the first element;
program instructions to modify the AR content by increasing a size of the graphical element related to the first element; and
program instructions to display, via the device associated with the user, the modified AR content within the visual information corresponding to the area.

9. The computer program product of claim 8, further comprising:
program instructions to determine an orientation corresponding the user within the physically bounded area based on the device;
program instructions to determine a field of view associated with a portion of the area based on the location and the orientation corresponding the user; and
program instructions to position the generated AR content within the determined field of view associated the area based on a location corresponding to the problem.

10-11. (canceled)

12. The computer program product of claim 8, wherein program instruction to display the generated AR content related to the problem further comprise:
program instructions to determine a rating respectively associated with the problem; and
program instructions to adjust one or more aspects of the generated AR content based on the determined severity rating respectively associated with the problem.

13. The computer program product of claim 8, wherein the problem includes one or more items selected from the group consisting of an out-of-specification operating condition, a deficiency within an infrastructure of the area, a deficiency associated with the physical element, and a hazard generated by the physical element.

14. The computer program product of claim 9, further comprising:
program instructions to determine that the user exits the physically bounded area; and
responsive to determining that the user exits the physically bounded area, modifying one or more aspects of the generated AR related to the problem displayed to the user.

15. A computer system comprising:
one or more computer processors;
one or more computer readable storage media; and
program instructions stored on the computer readable storage media for execution by at least one of the one or more computer processors, the program instructions comprising:
program instructions to monitor a location of a user according to a device worn by the user;
program instructions to, responsive to the location of the user being within a physically bounded area, receive visual information from the device, the visual information corresponding to the physically bounded area, the visual information including a plurality of physical elements within the physically bounded area;
program instructions to, responsive to receiving the visual information, collect sensor data from a group of sensors within the physically bounded area and historical problem data for the plurality of physical elements;
program instructions to identify a problem that exists with the plurality of physical elements in the physically bounded area in which the user is located by analyzing the sensor data and historical problem data;
program instructions to, responsive to identifying the problem, determine a set of contextual information associated with the problem including a location of a first element of the plurality of physical elements;
program instructions to generate augmented reality (AR) content from graphical elements related to the problem and the first element;
program instructions to modify the AR content by increasing a size of the graphical element related to the first element; and
program instructions to display, via the device associated with the user, the modified AR content within the visual information corresponding to the area.

16. The computer system of claim 15, further comprising:
program instructions to determine an orientation corresponding the user within the physically bounded area based on the device;
program instructions to determine a field of view associated with a portion of the area based on the location and the orientation corresponding the user; and
program instructions to position the generated AR content within the determined field of view associated the area based on a location corresponding to the problem.

17-18. (canceled)

19. The computer system of claim 15, wherein program instruction to display the generated AR content related to the problem further comprise:
program instructions to determine a rating respectively associated with the problem; and
program instructions to adjust one or more aspects of the generated AR content based on the determined severity rating respectively associated with the problem.

20. The computer system of claim 16, further comprising:
program instructions to determine that the user exits the physically bounded area; and
responsive to determining that the user exits the physically bounded area, modifying one or more aspects of the generated AR related to the problem displayed to the user.

21. The computer system of claim 16, wherein the problem includes one or more items selected from the group consisting of an out-of-specification operating condition, a deficiency within an infrastructure of the area, a deficiency associated with the physical element, and a hazard generated by the physical element.

22. The method of claim 1, wherein:
identifying a problem includes identifying a plurality of problems associated with one or more of the plurality of physical elements; and
the AR content is further related to a combined effect of the plurality of problems including a second element; and
further comprising:
analyzing the plurality of problems for the combined effect of the plurality of problems.

23. The method of claim 1, further comprising:
determining the plurality of physical elements with reference to a list of elements and corresponding locations of elements, the list of elements including the plurality of physical elements within the physically bounded area.
